(19) United States
(12) Patent Application Publication
(10) Pub. No.: US 2007/0016864 A1
(43) Pub. Date: Jan. 18, 2007

(54) System and method for enriching memories and enhancing emotions around specific personal events in the form of images, illustrations, audio, video and/or data

(76) Inventors: Bernard C. Kummerli, Liestal (CH); Jeffrey Smith, San Mateo, CA (US); Selwyn Wan, Vancouver (CA); Steve Israelson, Vancouver (CA); Ryan Patrick McCormack, San Francisco, CA (US); Henry Winston Wier III, San Francisco, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/372,867

(22) Filed: Mar. 9, 2006

Related U.S. Application Data
(60) Provisional application No. 60/660,192, filed on Mar. 10, 2005.

(51) Int. Cl. H04N 5/44

(52) U.S. Cl. 715/716

(57) ABSTRACT

A system and method for enriching memories and enhancing emotions about a specific personal event is disclosed. The system allows an easy to use enrichment of memories in terms of emotions and feelings around personal events such as vacations, promotions, sports, celebrations, etc. in form of still images, illustrations, templates, audio, video, and/or data. The invention is a turn-key system that combines broadly available hardware, industrial design, software, proprietary content, user-friendly user interface, distribution, and services tailored towards emotional personal events.

### PRIORITY CLAIM

This application claims priority under 35 USC 119(e) and 120 to U.S. Provisional Patent Application Ser. No. 60/660,192 filed on Mar. 10, 2005 entitled “System to Enrich Memories Around Specific Events in the Form of Images, Illustrations, Audio, Video and/or Data” which is incorporated herein by reference.

### FIELD OF THE INVENTION

The invention relates generally to a system and method for enriching memories and enhancing emotions around a specific personal event by combining proprietary content with personal content.

### BACKGROUND OF THE INVENTION

Today, many companies offer technologies, software, and/or services to allow the storage, editing, duplication, and sharing of personal still images, video, audio, animations, and/or data. However, most technology companies who offer hardware, software or services around memories related to personal events have the following shortcomings:
Most companies offer only one system element as for example storage technology or sharing software.
Many technologies are difficult to use and require a significant amount of learning, training, and/or tutoring.
There are no turnkey systems available that allow the combination of personal still images, audio, video and/or data with event specific images, audio, video, animations and/or data resulting in a higher emotional involvement of the observer.
Most offerings require a substantial amount of investments in form of storage, editing, duplication, and sharing hardware, software, and/or services.
All offerings are of a generic nature and do not tailor their offering(s) around specific personal events.

Thus, it is desirable to provide a system and method for enriching memories around a specific event that overcomes these limitations with typical solutions and it is to this end that the present invention is directed.

### SUMMARY OF THE INVENTION

A system and method for enriching memories and enhancing emotions around a specific personal event using one or more of images, illustrations, audio, video and data are provided. The system allows a highly user-friendly enrichment of memories in terms of emotions and feelings around personal events in form of one or more of still images, illustrations, audio, video, and data. The system permits the user to combine personal content and proprietary content and permits the user to change the personal content freely. The personal events may include vacations, promotions, sports, celebrations, etc. The invention is a turn-key system that combines broadly available hardware, industrial design, software, proprietary content, user-friendly user interface, distribution, and services tailored towards highly emotional personal events such as vacation, celebrations, sports, etc. The system combines personal content and proprietary content so that it provides a unique combination of personal data, still images, video, animations and/or audio around a specific personal event. The system provides a solution that is broadly accessible since the invention leverages hardware and software that is broadly available and highly penetrated in usage such as personal computers, digital cameras, cell phones, camcorders or software for capturing, editing, and sharing content.

Thus, in accordance with the invention, an apparatus and method for enriching memories and enhancing emotions about an event is provided. The apparatus includes a memory device that is capable of being coupled to a computing device wherein content contained on the memory device is executed by a processor of the computing device when the memory device is coupled to the computing device. The memory device has an event presentation application and a viewer application. The event presentation application generates a user interface that permits the user to load one or more pieces of user content about an event into the event presentation application and generates a presentation based on the one or more pieces of user content about the event. The viewer application displays the presentation generated by the event presentation application.

### BRIEF DESCRIPTION OF THE DRAWINGS

FIG. 1 illustrates an example of an event enhancement device in accordance with the invention;

FIG. 2 illustrates an example of an implementation of the event enhancement system in accordance with the invention;

FIG. 3 illustrates a method for device start-up of the event enhancement system;

FIG. 4 illustrates a method for creating an event enhancement presentation in accordance with the invention;

FIG. 5 illustrates an example of a splash screen for an event enhancement application;

FIG. 6 illustrates an example of a gallery screen for an event enhancement application;

FIGS. 7A, 7B and 7C illustrates examples of images in a gallery of the event enhancement application;

FIG. 8 illustrates an example of images placed into a presentation of the event enhancement application;

FIG. 9 illustrates another example of images placed into a presentation of the event enhancement application;

FIG. 10 illustrates a method for previewing a presentation of an event in accordance with the invention;

FIG. 11 illustrates a method for copying a presentation of an event in accordance with the invention;

FIG. 12 illustrates an example of a user interface for selecting a show of the event enhancement application;

FIG. 13 illustrates an example of a user interface for viewing an image of the event enhancement application;

FIG. 14 illustrates an example of a user interface for viewing a postcard of the event enhancement application;

FIG. 15 illustrates an example of a user interface for a video show of the event enhancement application;

FIG. 16 illustrates an example of a user interface of the event enhancement application for the slideshow device; and

FIG. 17 illustrates an example of a user interface for the event enhancement application for viewing the slideshows of the slideshow device.

### DETAILED DESCRIPTION OF A PREFERRED EMBODIMENT

The invention is particularly applicable to a system implemented on a flash memory device, such as a USB memory stick, and it is in this context that the invention will be described. In a preferred embodiment, the system may be implemented as one or more pieces of software and data stored on flash memory device that may be executed by a personal computer. It will be appreciated, however, that the system and method in accordance with the invention has greater utility since the invention can be implemented using other technology, hardware and/or software that are within the scope of the invention.

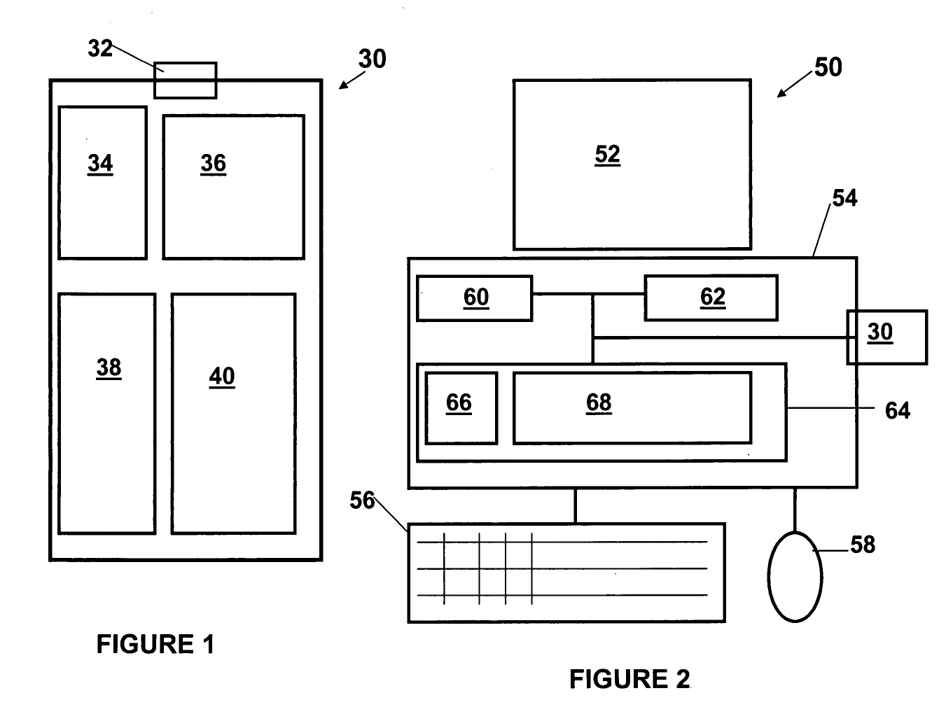

FIG. 1 illustrates an example of an event enhancement device 30 in accordance with the invention. The event enhancement device 30 may be any portable device that is capable of storing content, data and/or application(s) that may be used to create a presentation for a specific event. In a preferred embodiment shown in FIG. 2, the device 30 may be a flash memory storage device, such as a USB memory stick, that may be plugged into a typical computing device and then used to generate a presentation for a specific event. The device 30 may also be other types of memory sticks/devices, secure data (SD) cards, portable disk drives and the like wherein the device may be plugged into/coupled with the various computing devices described below with reference to FIG. 2. For example, the device 30 may be a memory device that is capable of being coupled to a mobile phone or PDA so that the event presentation application and viewer application can be run on the mobile phone or PDA. The device 30 may include a connector 32 that permits the device 30 to be connected to/coupled to any computing device, such as a personal computer system shown in FIG. 2. The device 30 may further have a viewer application 34, an event presentation application 36, a proprietary content storage unit 38 and a user content storage unit 40. In a preferred embodiment, the items 34-40 shown in FIG. 1 may each be one or more pieces of software code that may be executed by a processor of a typical computing device. The viewer application 34 may be a device/application that is used to display one or more set of images and/or a slide show and/or a video. The event presentation application 36 may be a device/application that is used to generate an event presentation based on a set of user content and propriety content for a specific event for a user. In a preferred embodiment, the event presentation application may be a software application written in a programming language such as C++ or C#. In a preferred embodiment of the system, the event presentation application and viewer application are both a piece of software comprising a plurality of lines of computer code and the functions of the event presentation application and viewer application are implemented when a processing unit of the computing device executes the lines of computer code. The proprietary content storage unit 38 may store various pieces of proprietary content, such as images, video content, audio content and postcard content, illustrations, templates, audio, video, animations, and/or data, that are unique to the device 30. The proprietary content may also be downloaded onto the device or the computing device by visiting a website or other storage location and selecting the particular pieces of proprietary content that is of interest to the particular user. The user content storage unit 40 may permit the user of the device 30 to store his/her content and then use that content to generate the event presentation in accordance with the invention. The user content may include content that is specific to an event, but may also include other user content such as audio content and the like that can be incorporated into a presentation that may be referred to as user content about an event.

The viewer application 34 may preferably be the commercially available Apple Computer Quicktime software application/plug-in. However, the viewer application may also be a custom software application that is programmed using a language such as C++ or C# and may include a commercially available media player such as a Windows media player or a Real Networks media player or a flash-based media player. The viewer application 34 may include an ability to adapt to the particular computing device onto which the viewer application is loaded so that the viewer application can operate acceptably (display the images and audio of the presentation) on a wide range of computing devices. Thus, the viewer application has an adaptive unit (not shown in FIG. 1) that implements an adaptive process to determine how the presentation is going to be displayed based on the hardware of the computing device (See the example of the implementation of the system in FIG. 2) available to the viewer application such as for example, a 3D graphics accelerator, system memory, processor speed, etc. . . . During the adaptive process, the viewer application adjusts a series of different parameters (three parameters in the preferred embodiment) depending on the type of hardware available to achieve smooth playback. Those parameters may include, for example:

Screen size wherein the presentation may appear full-screen (whatever the user has set) or in the 800×600 image mode with gray border;

Graphic size wherein the image presentation is either full size (1024×768) or has a reduced size (512×512); and

Full KBE (Ken Burns Effect), cross-fade transitions or cut transitions.

Each of these exemplary parameters is now described in more detail. The screen size is determined by the processor speed, and the availability of a 3D graphic accelerator with sufficient graphics memory. If the minimum hardware is not available then the 800×600 image with gray border mode is used. Otherwise, the full screen mode is used.

The graphic size affects the quality of the images being displayed. Thus, if the 3D graphic accelerator does not support high definition textures, then 512×512 graphics are used. Otherwise, full size (1024×768) graphics are used.

The Full KBE (Ken Burns Effect) means that the presentation incorporates the ability to pan and zoom in/out on still images and photos during the presentation instead of still images. The Full KBE requires a huge amount of processing power that is typically not available on the target computer platforms for the viewer application. In order to playback using KBE on full-screen, a suitable 3D graphic accelerator must be present. If the required 3D graphics accelerator is not available then the KBE may be dropped and cross-fade or the cut transition is used depending on the available processing speed.

The device, when inserted into a computing device, permits the user to change his/her personal content at any time, for any presentation and on any device that is inserted into the computing device. In addition, a presentation created using a particular device can be displayed/played on other devices or other computing devices so that the presentations can be shared. Now, an example of an implementation of the event enhancement system will be described.

FIG. 2 illustrates an example of an implementation of the event enhancement system 50 in accordance with the invention. In the preferred embodiment of the event enhancement system, the system is implemented on a computing device such as the personal computer shown in FIG. 2. The computing device may also be a terminal/mainframe computer system, a client/server computer system, a web-based system, a laptop computer system, a tablet computer system, a PDA, a mobile phone, a set-top box for digital televisions, a television set or a commercially available digital photo frames and the like since the system can be implemented on any computing device with sufficient processing power, memory and display capabilities. The system 50 may have a display device 52, such as a CRT or LCD, a chassis 54 and one or more input/output devices such as a keyboard 56 and a mouse 58 that permit the user to interact with the device 30 that may be coupled to the system 50 wherein the items in the device 30 (shown in FIG. 1 that may be implemented as pieces of computer code) may be executed by the computing device. The chassis 54 has a processing unit 60, a persistent storage device 62 and a memory 64 as is well known. When the computing device is used to implement the event enhancement system, the memory 64 may store an operating system 66 and an image application 68 executed by the processing unit 60 to implement the functions and steps of the event enhancement method described below.

In accordance with the invention, the device 30 may have a personal event theme associated with the device and the proprietary images contained on the device 30. For example, a Swiss vacation themed device 30 may be sold (and is currently being commercially sold by Philm at www.philm.com) in which a user may insert images, such as images from a Swiss vacation. The device may also have a child theme, a birthday theme, a vacation theme, a celebration theme, a sports theme, a promotions theme, a religion theme, etc. Alternatively, the device 30 may be a slideshow device 30 that permits the user to include whatever personal images that are desired by the user (along with some proprietary content such as audio) and the device creates one or more presentations (as described below) from these images. In a preferred embodiment, five presentations may be stored on a single slideshow device.

In the operation of the preferred embodiment, the device may be coupled to the computing device so that the event presentation application is downloaded to the computing device (into memory or installed on the persistent storage device of the computing device) and executed by the processing unit of the computing device. The event presentation application may, if needed, download the viewer application from the device onto the computing device and install the viewer application. The details of the functions and steps performed by the event presentation application and viewer application will now be described in more detail.

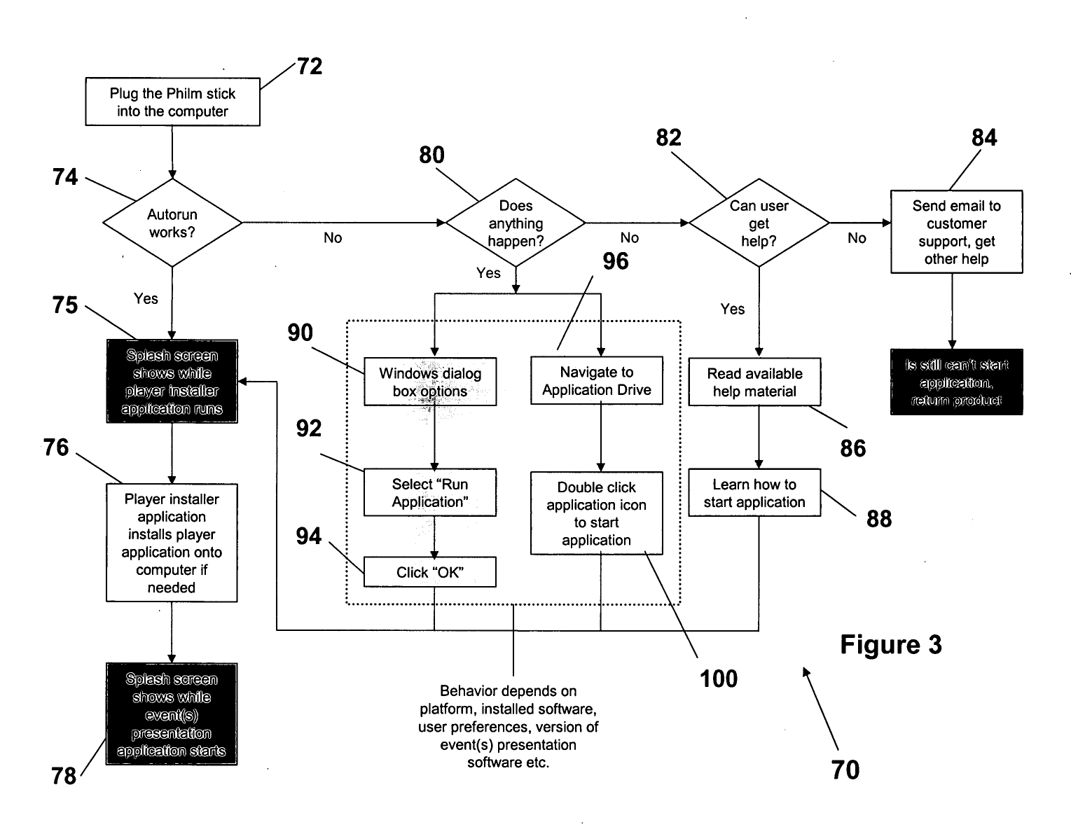

FIG. 3 illustrates a method 70 for device start-up of the event enhancement system. In step 72, the device shown in FIG. 1 is coupled to the computing device. In step 74, the event presentation application determines if the autorun application works. If the autorun does work, then a splash screen is shown while the player installer application is run in step 75 and the player installed application (that is part of the event presentation application) is started in step 76. In step 78, a background application and content application installer is run. The content application installer determines if a particular viewer application is installed on the computing device and then installs the content application if it is not installed or if an older version of the content application is already installed.

Returning to step 74, if the autorun does not work, then the user determines if anything happens in step 80 and, if nothing happens, the user can get help in step 82. If the user cannot get help (such as if the user does not have a connection to the internet or the quick reference guide embedded into the application does not resolve the problem), then the user is able to send an email to customer support or get other help in step 84. If those help options do not work, the user may opt to return the product. If the user can get help, then the user can read the available help material in step 86 and learn how to start the event presentation application in step 88. When the user has determined how to start the event presentation application, the splash screen is started in step 75 as described previously.

Returning to step 80, if something does happen, the start-up method steps depend on the computing device platform, installed software, user preferences, version of the event presentation application, etc. of the computing device. In step 90, a Windows dialog box is opened, the user selects “Run Application” in step 92 and the user click on “OK” in step 94 and then goes to step 76. Alternatively, in step 96, the user navigates to the location where the application resides and the user may double-click on an application icon in step 100. Now, a method for creating an event enhancement presentation will be described in more detail.

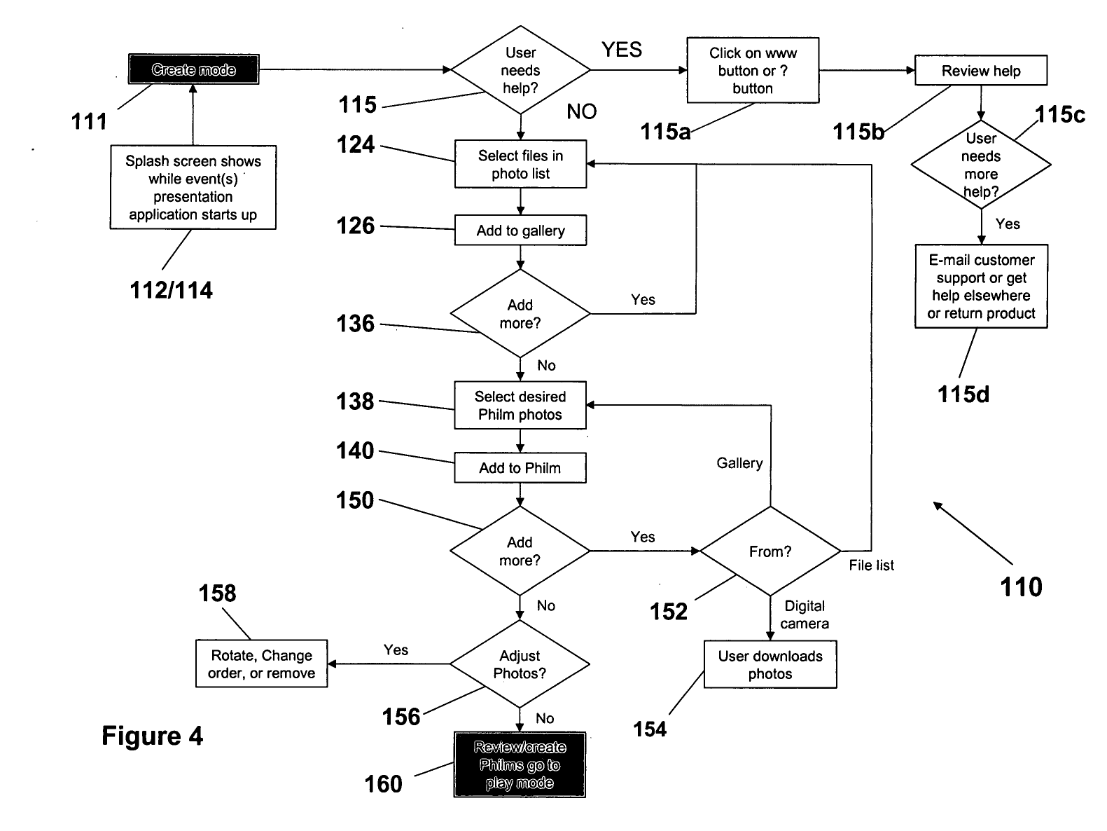

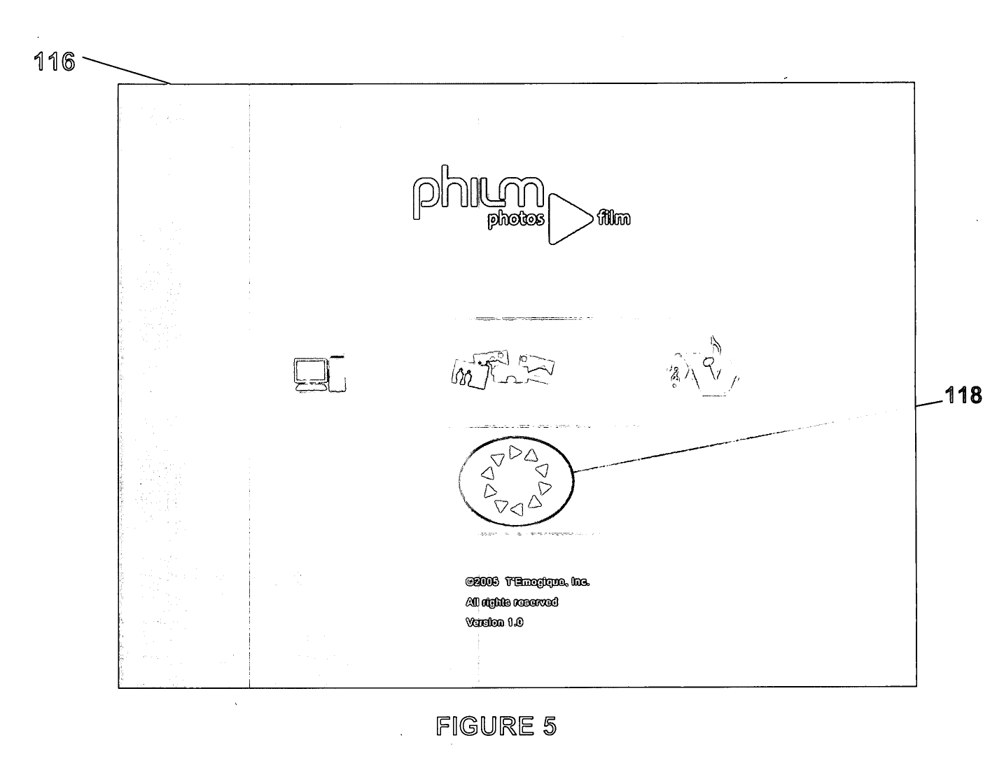

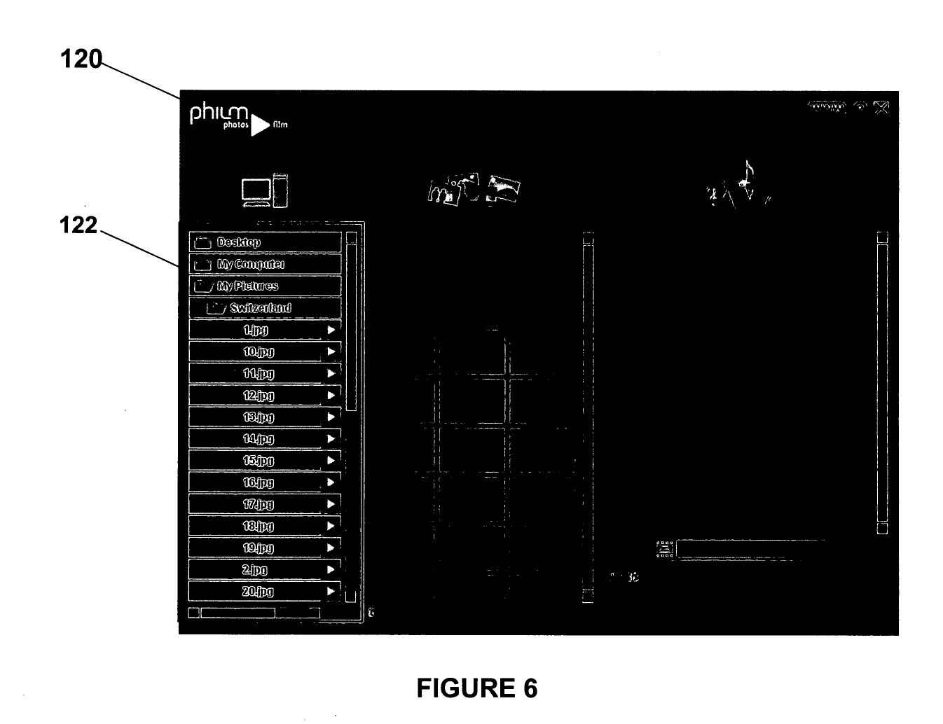

FIG. 4 illustrates a method 110 for creating an event(s) enhancement presentation in accordance with the invention. The steps and methods shown in FIGS. 4 and 10-11 are preferably performed by the event presentation application that is part of the device 30 described above wherein each step is implemented as a piece of computer code that executes on the processing unit 60 of the computer 50 in the preferred embodiment. In step 112, the event presentation application is started and a splash screen is shown in step 114 so that a create mode is entered in step 111. An example of a splash screen 116 of the event enhancement application in shown in FIG. 5. Thus, after a memory device has been connected to a computer (such as via a USB port), the splash screen is displayed while the software on the device needed for the event presentation is loaded onto the computer. An animation 118 of the arrows lets the user know that the event presentation application is being loaded (including a check for an image presentation application and the appropriate version of the image presentation application.) Once the appropriate version of the image presentation software is available on the computer, an image gallery user interface is shown to the user. An example of a gallery user interface 120 of the event enhancement application is shown in FIG. 6. An area 122 of the gallery scans the computer into which the device is inserted and locates folders with image files, such as JPG files, and displays those folders in the area 122. When the user clicks on a displayed folder, the folder opens up and the individual image files within the folder are shown to the user such as the images in the folder “Switzerland” as shown in FIG. 6.

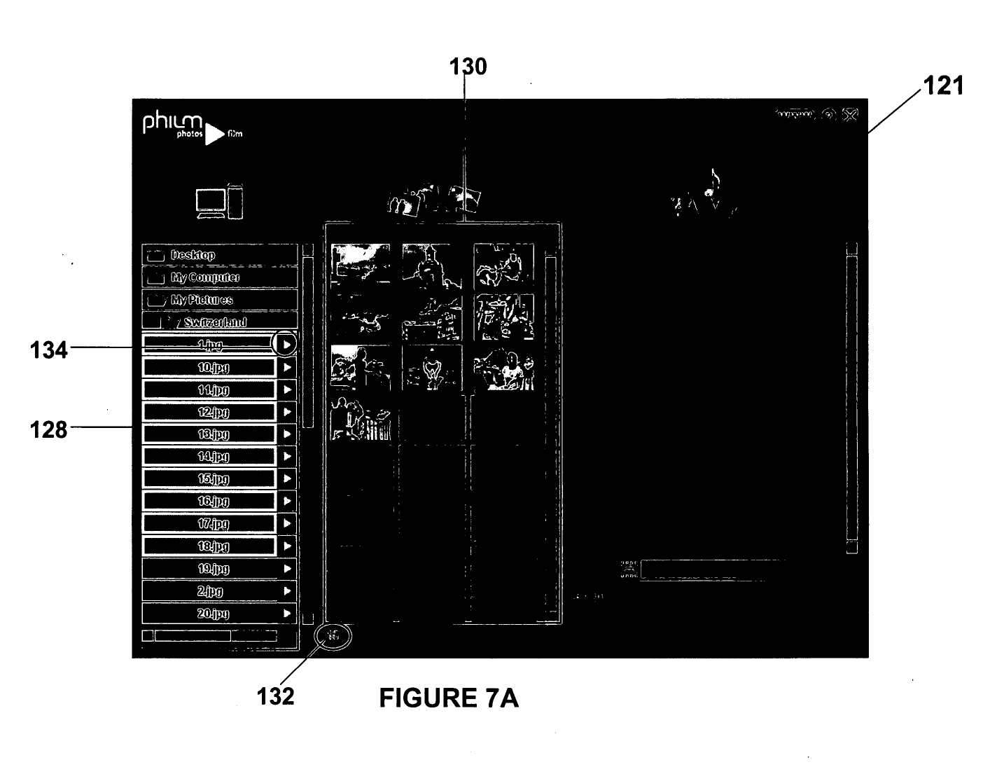

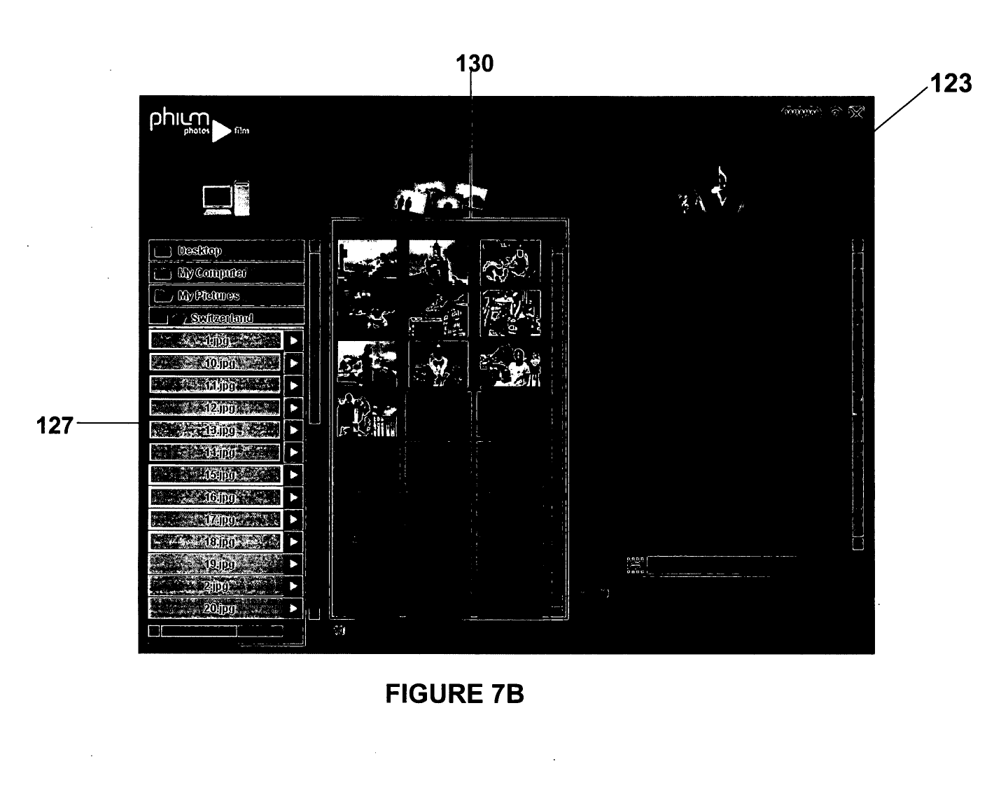

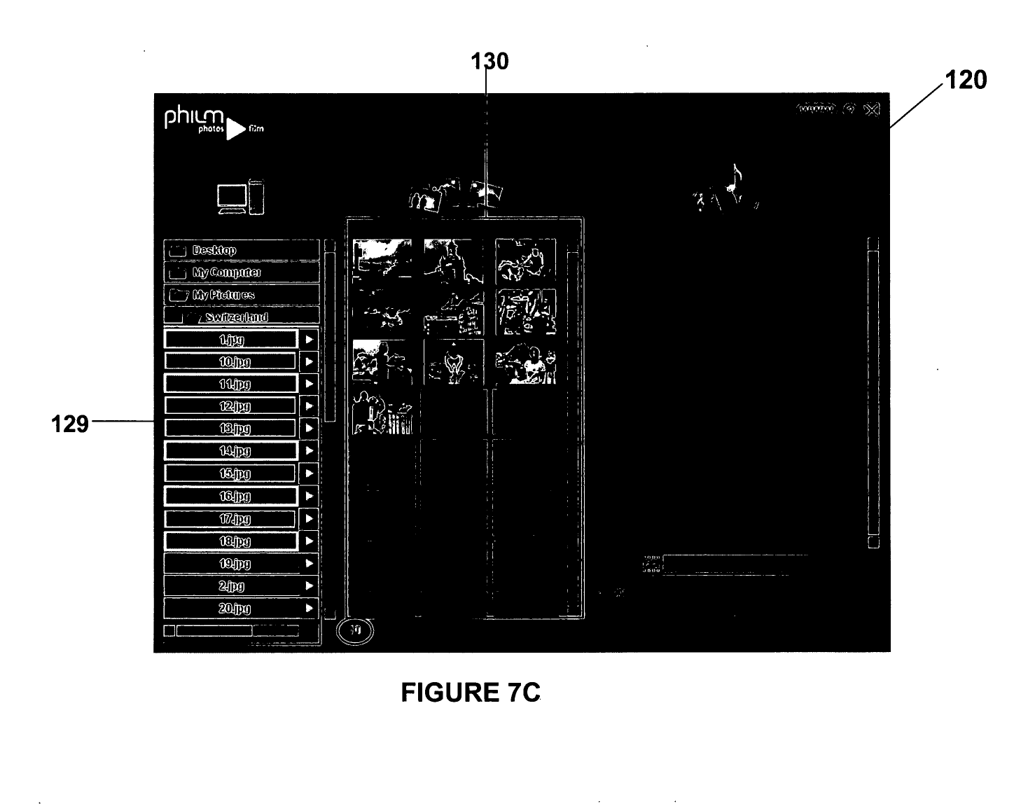

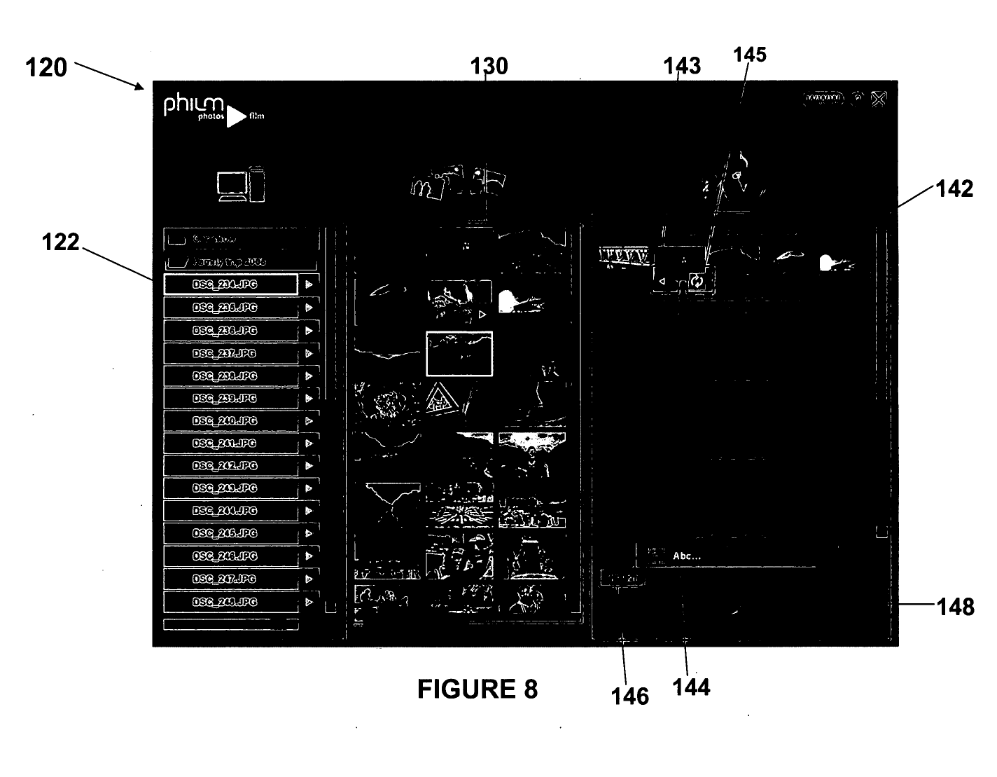

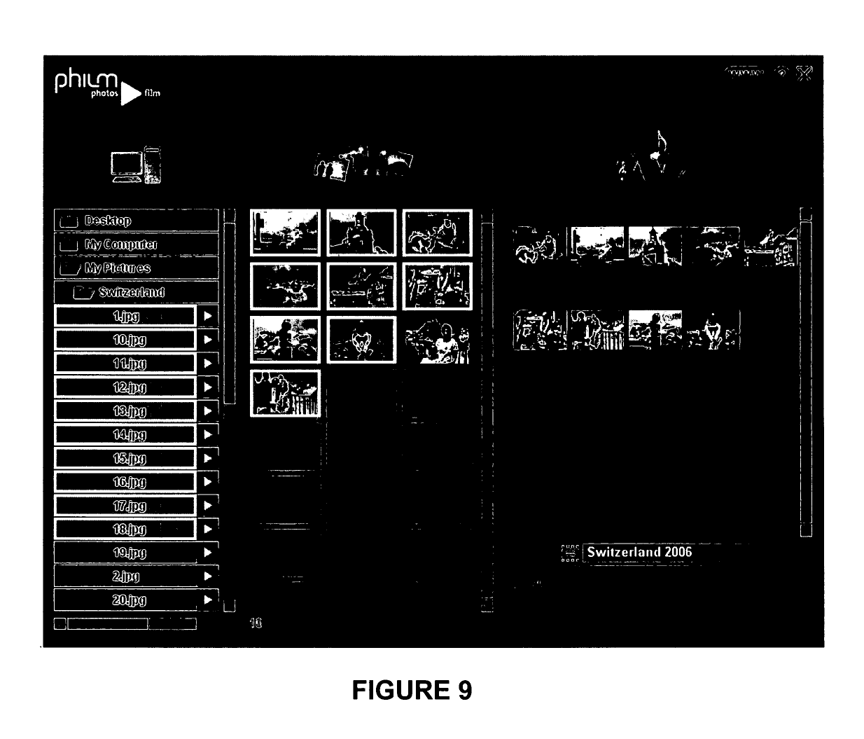

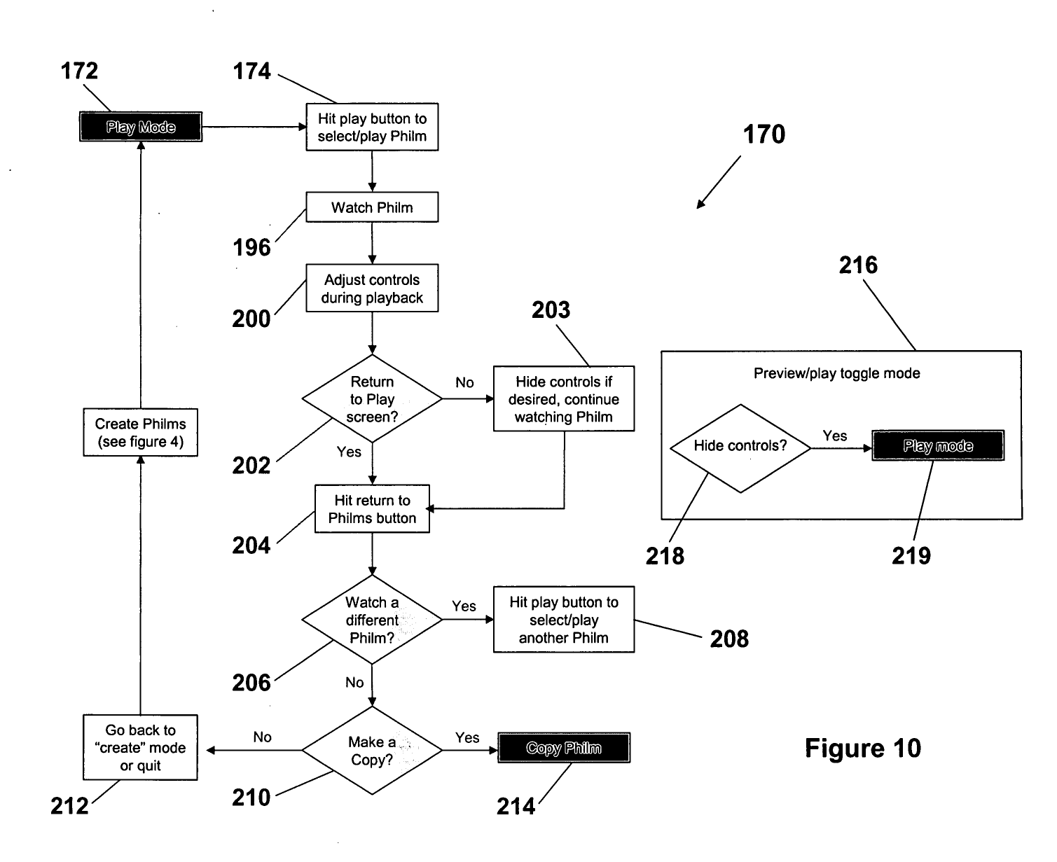

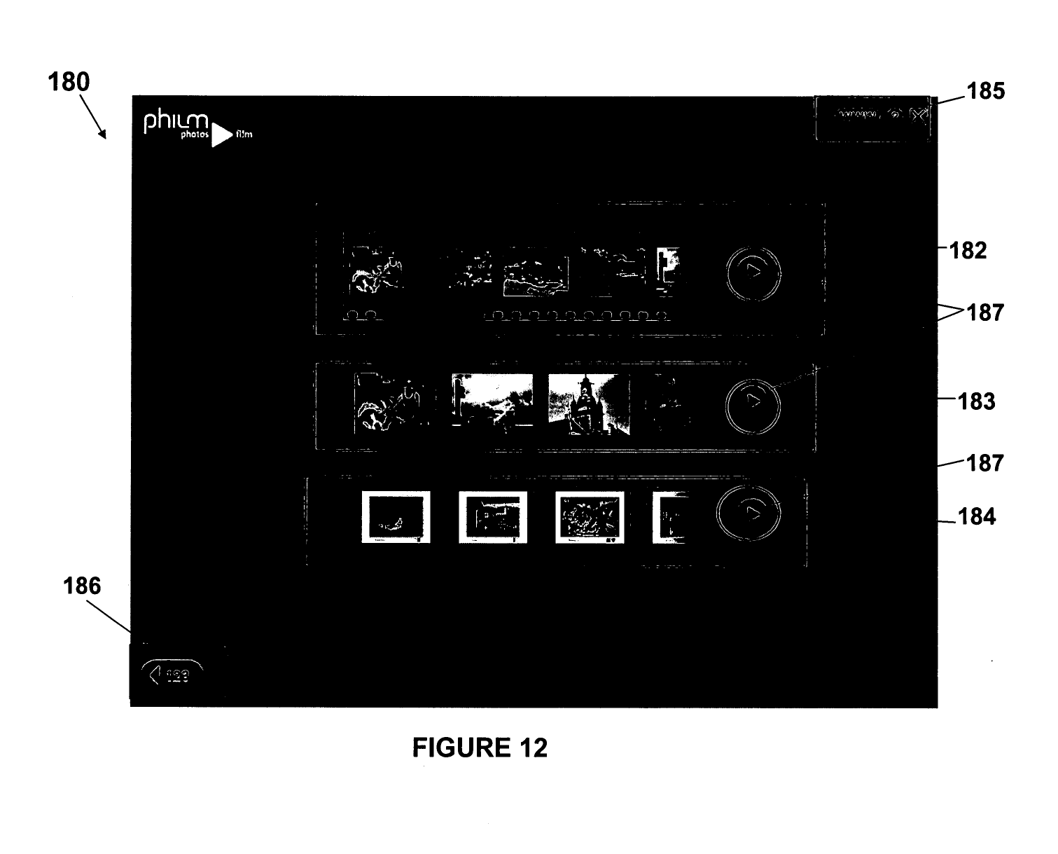

Returning to FIG. 4, the user determines if he/she needs any help in step 115. If the user needs help, the user may click on a link to a website or help button (shown in FIG. 12 as element 185) in step 115a. The user may then review the help in step 115b and determines if the user needs more help in step 115c and permit the user to email customer support, get other help or return the product in step 115d. If the user does not need any help, then the user may select one or more images from the folders in the area 122 in step 124 and add those selected images to a gallery in step 126. These steps are shown in FIG. 7A that shows the gallery user interface 120 wherein a set of images 128 in area 122 are selected and dragged over into a gallery area 130 wherein the images are shown as thumbnails to the user. A counter 132 (10 in this example) counts the number of images selected from the folders and placed into the gallery. To select an individual image, the user may click on an arrow 134 at the right of each image to copy the image into the gallery 130. To avoid duplicate copying of images, the area 122 has the already selected images highlighted by white borders as shown in FIG. 7A. FIGS. 7B and 7C show alternative ways that the user may move images into the gallery 130. In FIG. 7B, the user may click on a first image and hold down the “shift” key when selecting the last images to select a block of images 127 that can then be dragged into the gallery 130. In FIG. 7C, the user hits the “Ctrl” key and selects an image so that the user can select a set 129 of images that are not in a block and then drag those images into the gallery 130. In step 136, the event presentation application determines if the user has more images to add. If the user does have more images to add, the method loops back to step 124 so that the user can select more images. If the user does not have any more images to select, then in step 138, the user selects the desired images and adds them into a presentation in step 140. FIG. 8 shows the gallery user interface 120 with the area 122 and the gallery portion 130 as well as a presentation portion 142. The user drags one or more images from the gallery 130 to the presentation portion 142. In the presentation portion 142, the user can reorder the images using a rotation button 145 and the order of the images will be the order of the images in the presentation. The user can also delete an image in the presentation portion 142 using a remove button 143 and then add new images into a presentation at any time. The presentation portion 142 may also have a title area 144 in which the user can type a name for the presentation. The presentation portion 142 may also have a counter 146 (05/20 images in the example in FIG. 8) that counts the number of images copied into the presentation portion 142 from the gallery portion 130. The presentation portion 142 may also have a show generation button 148 (preferably a red button in one embodiment of the invention) that automatically generates a presentation based on the images in the presentation portion 142. FIG. 9 also shows an example of the gallery user interface 120 with the presentation portion and the images.

Returning to FIG. 4, the event presentation application determines if the user has more images to add to the presentation in step 150. If the user has more images, then the event presentation application determines the source of the new images in step 152. If the new images are from the gallery, then the method loops back to step 138. If the new images are from an external source, such as a digital camera, the method permits the user to download the new images from the external device into the event presentation application (and into a folder on the computing device) in step 154. If the new images are from the file list, the method loops back to step 124. If there are no more images to add to the presentation, then the user determines if any images need to be adjusted in step 156. If the user wants to adjust the images, then in step 158, the user can rotate one or more images by clicking on the rotation button 145 shown in FIG. 8, change the order of the images and/or remove one or more images from the presentation and then loop back to step 156. If the user does not need to adjust the images, then in step 160, the presentation may be previewed (the user can see which images are in the presentation) or played by the user clicking on the play button 148 to take the user to the screen shown in FIG. 12. In accordance with the invention, the presentation generated by the system may include a slideshow, a video show or a digital post card show.

FIG. 10 illustrates a method 170 for previewing a presentation of an event in accordance with the invention wherein the presentation is created in accordance with the flowchart shown in FIG. 4 shown as step 172 here. The event presentation application defaults to playing photos and videos when the user hits the play button in step 174 (the red button described above with respect to FIG. 8). FIG. 12 illustrates a presentation play user interface 180 wherein the user may select a slideshow 183, a video show 182 or a digital postcard show 184. For the Swiss themed device and other themed devices, the video show may include the user images as well as proprietary images and video clips on the device 30 combined together with transitions between the images and the images and the video and zooming in/out and panning to provide the KBE as described above as well as proprietary audio content. The slideshow for the themed devices may include the user content and proprietary image content and the proprietary audio content with transitions. For the slideshow device, the slideshow may include the content of the user with transitions between slides and KBE. The digital postcard presentation may include the user content and proprietary content (audio and images) combined into the digital postcards, but does not have the KBE although it does permit graphics elements to be added to the pictures. The user interface 180 may further include a set of controls 185 that permits the user to go to the support website at www.philm.com, to a help screen or to exit the event presentation application using these controls. The user interface may also include a button 186 that takes the user back to the previous user interface screen discussed above and a play button 187 for each type of presentation that allows the user to play the particular type of presentation.

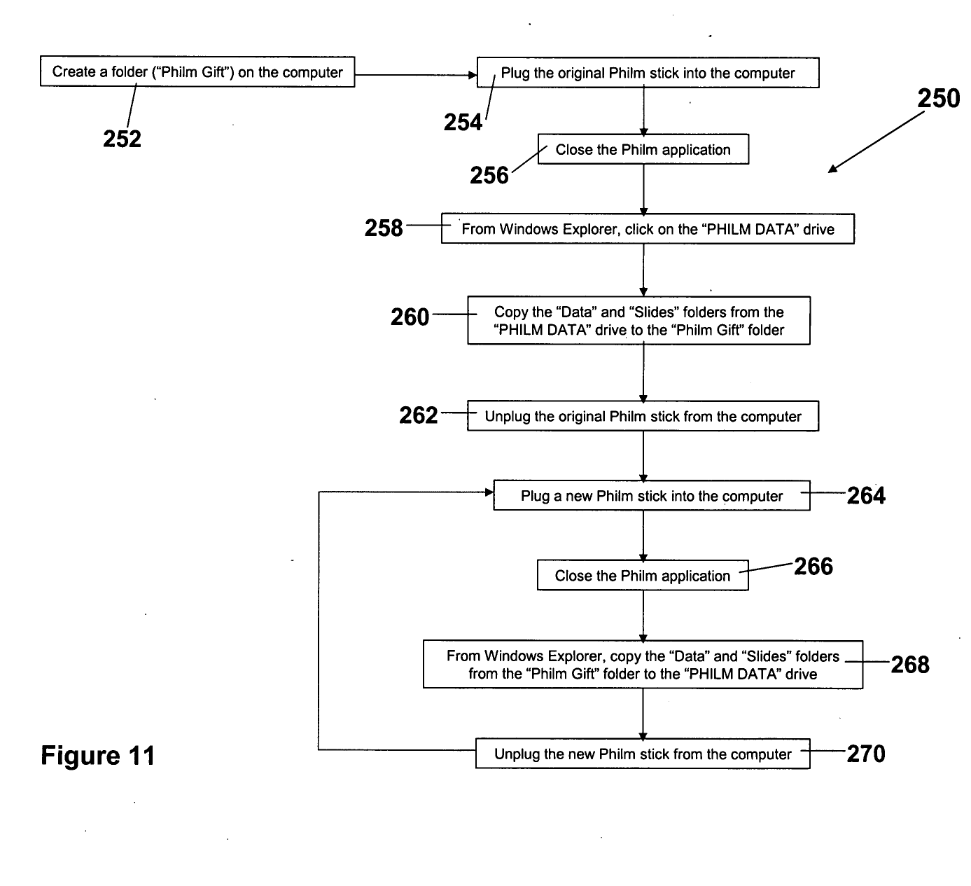

Returning to FIG. 10, in step 196, the user watches the presentation in full screen mode. In step 200, the event presentation application allows the user to or automatically adjusts the controls during playback. In step 202, the event presentation application determines if the user wants to return to the play screen. If the user does not want to return to the play mode, in step 203, the event presentation application hides the controls, if desired, and the user continues with the presentation. In step 204, the user may hit the return to the presentation button. In step 206, the event presentation application determines if the user wants to watch a different presentation in step 206. If the user wants to watch a different presentation, the user selects a different presentation in step 208 and loops back to step 174. If the user does not want to watch another presentation, then the user decides if he/she wants to make a copy of a particular presentation in step 210. If the user does not want to make a copy, then goes back to the create mode or quits in step 212 and the method loops back to step 172. If the user does want to copy the presentation, a copy presentation step 214 that is described in more detail with reference to FIG. 11. The method may also include a toggle 216 between a preview mode and a play mode wherein, from the play mode, the event presentation application asks the user to hide the controls in step 218 and then enters a play mode 219. Now, the user interfaces shown to the user during a presentation are described in more detail.

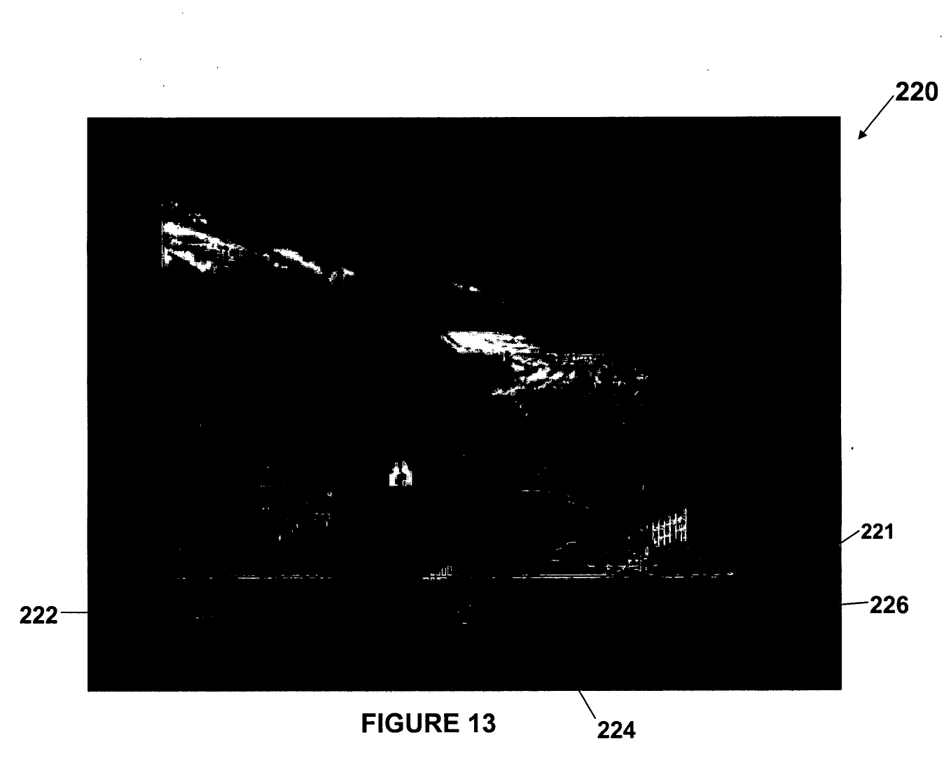

FIG. 13 illustrates an example of a user interface 220 for viewing an image of the event enhancement application. In particular, the slide show format is shown. In addition to the image (which may be either a user image or a proprietary piece of content), the user interface may include a control bar 221 that is normally shown in phantom and not usable by the user, but becomes active when the cursor rolls over the area. The control bar may include a back button 222 that, when pressed, takes the user to the prior play screen, a set of play control buttons 224 and a volume control button 226 that controls the volume of the audio content. The set of play control buttons may include a back button, a pause button, a play button and a forward button that allows the user to control the display of the content in the slide show.

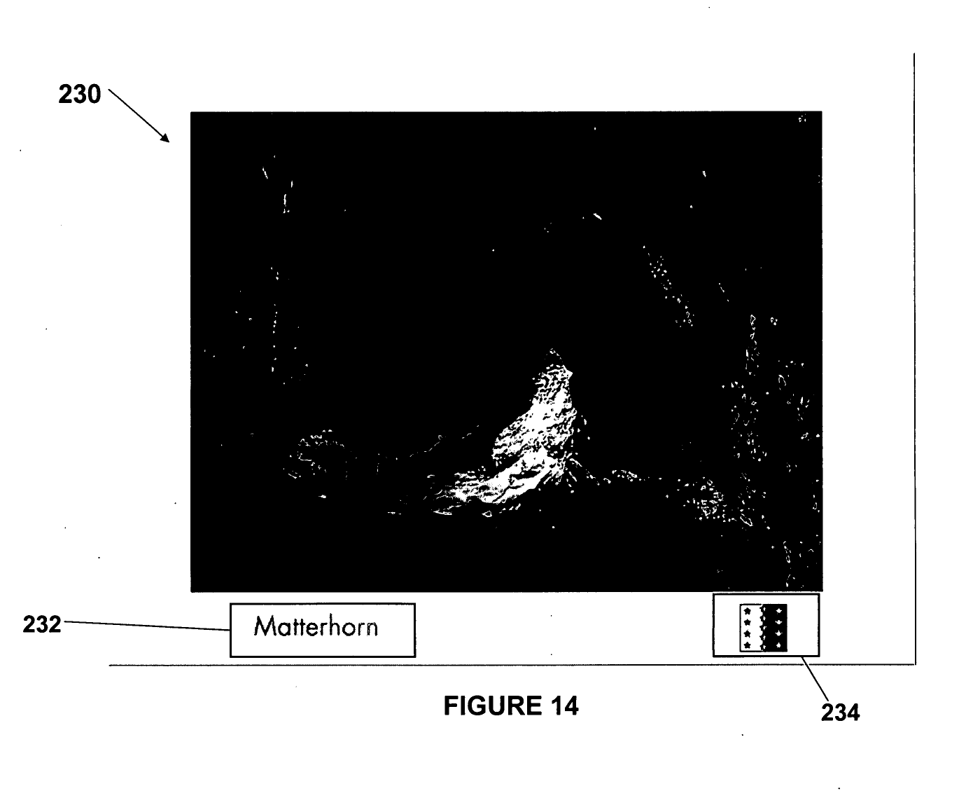

FIG. 14 illustrates an example of a user interface 230 for viewing a postcard of the event enhancement application. In particular, this user interface shows the digital post card show format presentation. In addition to the content (a proprietary image) shown, the user interface may include a location indicator 232 indicating the area where the particular image was taken and a canton indicator 234 that shows the canton flag for the particular location shown. The example shown in FIG. 14 is the Swiss themed device so that the flags of the Swiss cantons are shown. As with the other user interfaces, the control bar is included. If another themed device is done, such as a Disney® device, the canton indicator might be replaced by the corporate logo of Disney® for example.

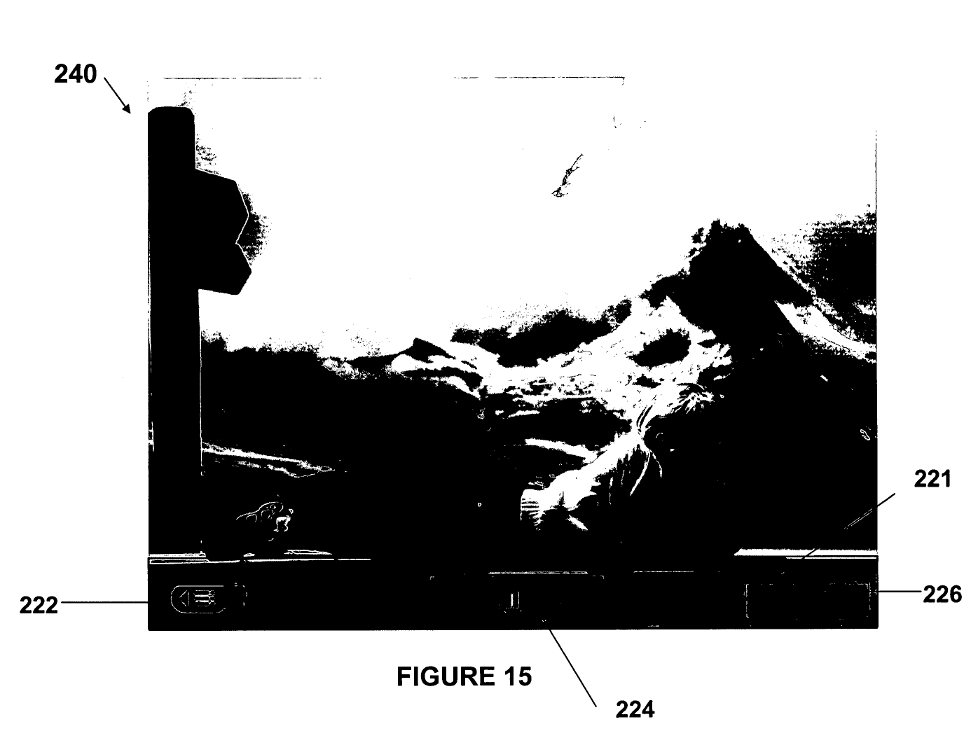

FIG. 15 illustrates an example of a user interface 240 for a video show of the event enhancement application. In particular, a presentation in the video show format is shown. This user interface 240 has the same control bar 221 and controls 222-226 as shown in FIG. 13 above. Now, a method for copying a presentation is described in more detail.

FIG. 11 illustrates a method 250 for copying a presentation of an event in accordance with the invention. In step 252, the user may create a folder (such as “Philm Gift”) on the computing device. It should be understood that one or more of the steps in this method can be automated. In step 254, the user plugs the original device into the computing device. In step 256, the user closes the event presentation application and, in step 258, uses Windows Explorer to click on the “Philm Data” drive (the representation of the device 30 in the Windows operating system). In step 260, the data and slides folders from the device 30 are copied into the folder on the computing device. During the process, the user's images are copied (slide folder), the order of the images is maintained and the audio is maintained. However, the video sequence that is part of the presentation remains random. In step 262, the original device is unplugged from the computing device. In step 264, the user plugs a new device into the computing device and closes the event presentation application in step 266. In step 268, using the Windows Explorer application, the user copies the data and slides folders from the “Philm Gift” folder onto the new device. In step 270, the new device with the copied presentation is unplugged from the computing device and the presentation has been copied.

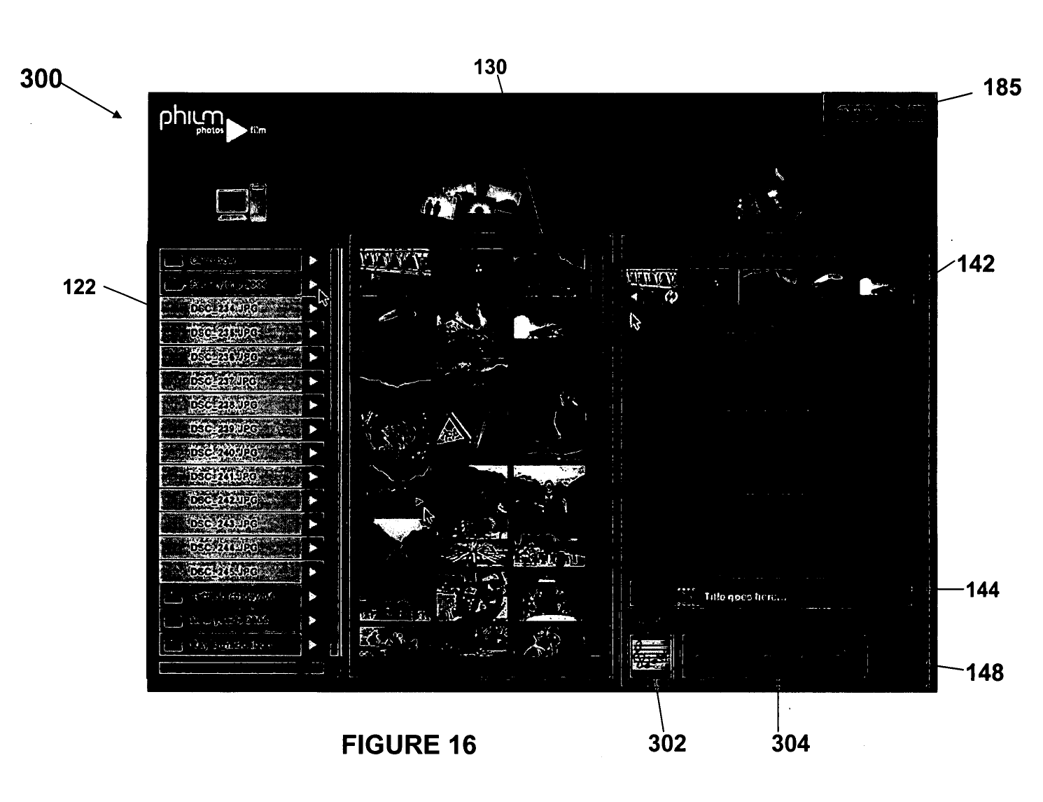

FIG. 16 illustrates an example of a user interface 300 of the event enhancement application for the slideshow device. In particular, the slideshow device described above has a slightly different user interface since the device only provides the user with the ability to create a slideshow. Like elements from the user interface described above have like reference numeral and operation and will not be described further for this figure unless the operation of those elements has changed for this figure. As shown in FIG. 16, this user interface has many of the same elements as the prior user interface. However, this user interface also has a music selection icon 302 and a slideshow selection control 304. Unlike the embodiment described above in which the audio content was assigned to each presentation in some manner, with the slideshow device, the user is able to select the particular audio content to include with his/her slideshow using the music selection icon. The slideshow selection control 304 permits the user to select the particular slideshow contained on the slideshow device. In a preferred embodiment, the slideshow device permits up to five slideshows to be created and saved.

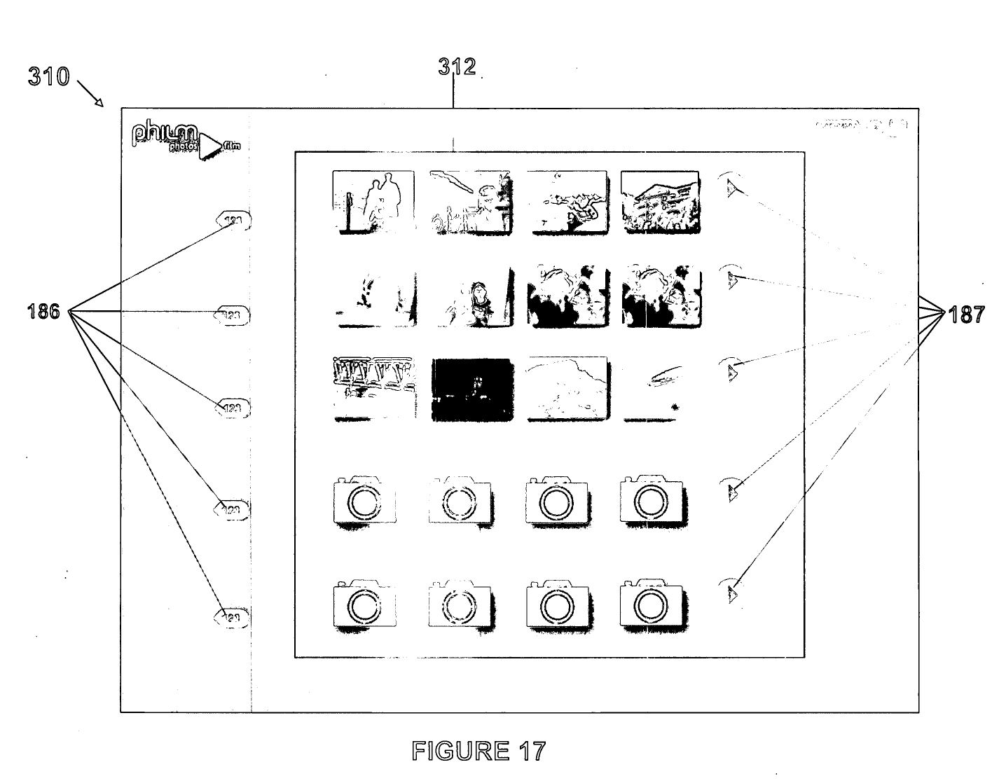

FIG. 17 illustrates an example of a user interface 310 for the event enhancement application for viewing the slideshows of the slideshow device. This user interface permits the user to view the slideshows on the slideshow device and the play them. As with FIG. 16, this user interface shares elements in common with above described user interfaces and these elements have the same functions as described above. This user interface may include a slideshow display portion 312 that permits the user to view thumbnails of the images assigned to each slideshow (note that the last two slideshows in the example shown in FIG. 17 are not currently being used) and then play each slideshow using the play button 187.

In accordance with the invention, the system architecture of the apparatus/system around one or more personal events and the system elements vary by personal event and market specifics. For the exemplary event presentation shown in the diagrams that depicts the device for a tourist market in Switzerland where the system aims at enhancing emotions and feeling around a visit or vacation in Switzerland, the system elements used may include: a USB flash memory device (device 30 in the diagrams) that plugs into a USB port of a typical personal computer; proprietary content such as Swiss specific content in form of images, templates, illustrations, videos, audio, animations, and/or data; the device is distributed in high tourist frequency areas; and software including a user interface wherein the software is embedded in the flash memory that creates a kind of film with images, information, and/or sound from the consumer with additional images, illustrations, templates, videos, data, animations, and/or sound around Switzerland from the systems provider.

While the foregoing has been with reference to a particular embodiment of the invention, it will be appreciated by those skilled in the art that changes in this embodiment may be made without departing from the principles and spirit of the invention, the scope of which is defined by the appended claims.

1. An apparatus for enriching memories and enhancing emotions about an event, comprising:
a memory device that is capable of being coupled to a computing device wherein content contained on the memory device is executed by a processor of the computing device when the memory device is coupled to the computing device;
the memory device further comprising an event presentation application and a viewer application; and
wherein the event presentation application generates a user interface that permits the user to load one or more pieces of user content about an event into the event presentation application wherein the event presentation application generates a presentation based on the one or more pieces of user content about the event and the viewer application is capable of displaying the presentation generated by the event presentation application.

2. The apparatus of claim 1, wherein the memory device further comprises one or more pieces of proprietary content having a particular theme associated with the event.

3. The apparatus of claim 2, wherein the event presentation application further comprises a unit that combines the one or more pieces of user content about the event with the one or more pieces of proprietary content to generate the presentation.

4. The apparatus of claim 2, wherein the proprietary content further comprises one of an image associated with the event, a template associated with the event, an illustration associated with the event, a video associated with the event, an audio portion, an animation associated with the event, and data associated with the event.

5. The apparatus of claim 1 further comprising a computing device having a processing unit and a port wherein the memory device is a portable memory device coupled to the port, the event presentation application being a piece of software having a plurality of lines of computer code wherein the processing unit of the computing device executes the plurality of lines of computer code of the event presentation application when the memory device is coupled to the port of the computing device.

6. The apparatus of claim 5, wherein the computing device further comprises one of a personal computer, a laptop computer system, a tablet computer system, a PDA and a mobile phone, a set-top box, a television and a digital photo frame.

7. The apparatus of claim 1, wherein the presentation further comprises one of a slide presentation, a video presentation and a postcard presentation.

8. The apparatus of claim 1, wherein the memory device further comprises one of a memory stick, a secure data memory device, a universal serial bus memory stick, a flash memory device and a portable disk drive.

9. The apparatus of claim 1, wherein the viewer application further comprises one of a Quicktime software application, a media player and a flash-based media player.

10. The apparatus of claim 1, wherein the event presentation application further comprises a unit for assessing the availability of a viewer application when the memory device is coupled to the computing device so that the viewer application is loaded onto the computing device when the viewer application is not present on the computing device or the viewer application is loaded onto the computing device when an older version of the viewer application is present on the computing device.

11. The apparatus of claim 5, wherein the viewer application further comprises an adaptive unit that adapts the display of the presentation to the capabilities of the computing device wherein the capabilities of the computing device include one or more of processor speed, memory and a graphics accelerator card.

12. The apparatus of claim 1 wherein the event presentation application further comprises a three column user interface having an image column, a gallery column and a presentation preview column.

13. A computer-implemented method for enriching memories and enhancing emotions about an event, the method comprising:
coupling a memory device to a computing device;
executing content contained on the memory device by a processor of the computing device when the memory device is coupled to the computing device wherein the content includes an event presentation application and a viewer application;
generating, using the event presentation application, a user interface that permits the user to load one or more pieces of user content about an event into the event presentation application;
generating, using the event presentation application, a presentation based on the one or more pieces of user content about the event; and
displaying, using the viewer application, the presentation generated by the event presentation application.

14. The method of claim 13, wherein the memory device contains one or more pieces of proprietary content having a particular theme associated with the event.

15. The method of claim 14, wherein generating the presentation further comprises combining the one or more pieces of user content about the event with the one or more pieces of proprietary content to generate the presentation.

16. The method of claim 14, wherein the proprietary content further comprises one of an image associated with the event, a template associated with the event, an illustration associated with the event, a video associated with the event, an audio portion, an animation associated with the event, and data associated with the event.

17. The method of claim 13, wherein coupling the memory device to the computing device further comprises inserting the memory device into a universal serial bus port of the computing device.

18. The method of claim 17, wherein the computing device further comprises one of a personal computer, a laptop computer system, a tablet computer system, a PDA and a mobile phone, a set-top box, a television and a digital photo frame.

19. The method of claim 13, wherein the presentation further comprises one of a slide presentation, a video presentation and a postcard presentation.

20. The method of claim 13, wherein the memory device further comprises one of a memory stick, a universal serial bus memory stick, a flash memory device and a portable disk drive.

21. The method of claim 13, wherein the viewer application further comprises one of a Quicktime software application, a media player and a flash-based media player.

22. The method of claim 13, wherein generating the presentation further comprises assessing, using the event presentation application, the availability of a viewer application when the memory device is coupled to the computing device and loading the viewer application onto the computing device when the viewer application is not present on the computing device or an older version of the viewer application is present on the computing device.

23. The method of claim 13, wherein displaying the presentation further comprises adaptively adjusting the display of the presentation based on the capabilities of the computing device that is executing the viewer application.

24. The method of claim 1, wherein generating the user interface further comprises generating a three column user interface having an image column, a gallery column and a presentation preview column.
